(19) United States
(12) Patent Application Publication
(10) Pub. No.: US 2019/0153204 A1
(43) Pub. Date: May 23, 2019

(54) RESIN COMPOSITION AND ARTICLE

(71) Applicant: IMERYS MINERALS LIMITED, Par Cornwall (GB)

(72) Inventor: Fatima REBIH, Toulouse (FR)

(21) Appl. No.: 16/300,081

(22) PCT Filed: May 12, 2017
(86) PCT No.: PCT/GB2017/051338

§ 371 Date: Nov. 9, 2018

(30) Foreign Application Priority Data
May 13, 2016 (GB) 1608480.8
Oct. 5, 2016 (GB) 1616913.8

(51) Int. Cl. C08L 23/12; C08L 23/06; C08K 5/09; C08K 5/3415; B29C 45/00

(52) U.S. Cl. CPC C08L 23/12; C08L 23/06; C08L 2203/202; C08K 5/3415; B29C 45/0001; C08K 5/09

(57) ABSTRACT

A resin composition, a cable or cable protection comprising or formed from said resin composition, a rotomolded article comprising or formed from said resin composition, an article of manufacture comprising or formed from said resin composition, for example, a plastic pallet, uses of said resin composition, use of a recycled mixed polyolefin stream comprising at least polypropylene and polyethylene in the manufacture of an article having an ESCR of at least about at least about 50 hours, a method of making an article having an ESCR of at least about at least about 50 hours, a method of making a resin composition, a method of making cable or cable protection, and a method of making a rotomolded article, a method of making a plastic pallet.

### TECHNICAL FIELD

The present invention is directed to a resin composition, to a cable or cable protection comprising or formed from said resin composition, to a rotomolded article comprising or formed from a resin composition, to uses of said resin composition, to the use of a recycled mixed polyolefin stream comprising at least polypropylene and polyethylene in the manufacture of an article having an ESCR of at least about at least about 50 hours, to a method of making an article having an ESCR of at least about at least about 50 hours, to a method of making a resin composition, to a method of making cable or cable protection, and to a method of making a rotomolded article.

### BACKGROUND OF THE INVENTION

There is an ever increasing demand to recycle and re-use polymer materials since this provides cost and environmental benefits. As the need to recycle polymer waste materials increase, there is a continuing need for the development of new ways to utilise recycled polymer materials.

### SUMMARY OF THE INVENTION

According to a first aspect, the present invention is directed to a resin composition comprising:
at least 5% by weight, or at least 10% by weight, or at least 15% by weight polypropylene (PP),
at least about 40% by weight of non-PP polymer,
at least about 1% by weight of a compatabilizer comprising inorganic particulate material and a surface treatment agent on a surface of the inorganic particulate,
wherein the resin composition is substantially free of a peroxide-containing additive.

According to a first aspect 1(a), the present invention is directed to a resin composition comprising, based on the total weight of the resin composition:
greater than about 50% by weight polypropylene (PP), or at least about 75% by weight PP,
up to about 30% by weight polyethylene, or up to about 25% by weight polyethylene, or free of polyethylene,
at least about 1% by weight of a compatabilizer comprising inorganic particulate material and a surface treatment agent on a surface of the inorganic particulate,
wherein the resin composition is substantially free of a peroxide-containing additive.

In certain embodiments of the first aspect 1(a), the resin composition has a MFI @ 190° C./2.16 kg of at least about 3.0 g/10 mins. In this and other embodiments, the resin composition comprises at least about 85% by weight PP and is substantially free of polyethylene.

According to a second aspect, the present invention is directed to a cable or cable protection comprising or formed from the resin composition according to the first aspect or first aspect 1(a).

According to a second aspect 2(a), the present invention is directed to an article of manufacture comprising or formed from the resin composition according to the first aspect or first aspect 1(a).

According to a third aspect, the present invention is directed to a rotomolded article comprising or formed from a resin composition according to the first aspect or first aspect 1(a).

According to a third aspect 3(a), the present invention is directed to an injected moulded article comprising of formed from a resin composition according to the first aspect or first aspect 1(a).

According to a fourth aspect, the present invention is directed to the use of a resin composition according to the first aspect in the manufacture of cable or cable protection.

According to a fourth aspect 4(a), the present invention is directed to the use of a resin composition according to the first aspect (1a) in the manufacture of an article, for example, a plastic pallet.

According to a fifth aspect, the present invention is directed to the use of a resin composition according to the first aspect to enhance the resistance to weathering or ESCR of a cable or cable protection formed therefrom.

According to a sixth aspect, the present invention is directed to the use of a recycled mixed polyolefin stream comprising at least polypropylene and polyethylene in the manufacture of an article having an ESCR of at least about at least about 50 hours, for example, at least about 150 hours, or at least about 250 hours, or at least about 400 hours, or at least about 500 hours, as may be determined in accordance with ASTM D1693-01 under Condition B.

According to a seventh aspect, the present invention is directed to a method of making an article having an ESCR of at least about at least about 50 hours, for example, at least about 150 hours, or at least about 250 hours, or at least about 400 hours, or at least about 500 hours, as may be determined in accordance with ASTM D1693-01 under Condition B, said method comprising forming said article from a resin composition which is derived from a mixed recycled polyolefin stream comprising polypropylene and polyethylene.

According to an eighth aspect, the present invention is directed to a method of making a resin composition according to the first aspect, comprising compounding the polypropylene and non-PP polymer, for example, polyethylene, with the compatabilizer and other optional additives other than a peroxide-containing additive.

According to an eighth aspect 8(a), the present invention is directed to a method of making a resin composition according to the first aspect 1(a), comprising compounding the polypropylene and optional polyethylene, with the compatabilizer and other optional additives other than a peroxide-containing additive.

According to a ninth aspect, the present invention is directed to a method of making cable or cable protection, the method comprising extruding a resin composition according to the first aspect to form said cable or cable protection.

According to a ninth aspect 9(a), the present invention is directed to a method of making an article, for example, a plastic pallet, the method comprising injection moulding a resin composition according to the first aspect 1(a) to form said article, for example, said plastic pallet.

According to a tenth aspect, the present invention is directed to a method of making a rotomolded article according to the third aspect, comprising forming the article by rotation moulding a resin composition according to the first aspect.

### DESCRIPTION OF THE INVENTION

The resin composition provides an effective polyolefin blend compatabilizer. Typically, this involves a two step process. Without wishing to be bound by theory, first, the surface treatment agent/coupling modifier reacts with the surface of the inorganic particulate at relatively low temperatures, and then the surface treated inorganic particulate is combined (at relatively higher temperatures) with the mixed polyolefin blend (comprising polypropylene (PP) and non-PP such as polyethylene (e.g., high density polyethylene (HDPE)), for example, by compounding, making its way to, and reacting with macro-radical fragments. Thermo-mechanical degradation of the polyolefinic components occurs during the combining (e.g., compounding) process generating the macro-radical fragments. PP may be degraded due to chain scission in the beta position, while the non-PP component, such as polyethylene, may crosslink due to macro-radical recombination. Typically, a relatively small amount of a peroxide-containing additive is added to catalyse the reactive extrusion process (for example, dicumyl peroxide decomposes when heated to form alkoxy radicals that, in turn, abstract hydrogen from the polymer backbone, forming polymer radicals, and polyolefins are prone to chain scission reactions in the presence of free radicals). Surprisingly, it has been found that resins having a relatively high PP content (e.g., polyethylene contaminated with PP) and having good or even improved mechanical/physical properties (e.g., elongation at break, impact strength and Environmental Stress Crack Resistance (ESCR)) can be obtained in the absence peroxide-containing additive. In this respect, and without wishing to be bound by theory, thermo-mechanical degradation of recycled polyolefins during the combining (e.g., compounding process) generates sufficient macro-radical fragments to react with the surface treated inorganic particulate material, which serves to decrease the interfacial tension between the immiscible polyolefin components, thus enabling enhanced mechanical physical properties, even in the absence of peroxide-containing additive. Moreover, it has surprisingly been found that the addition of a peroxide-containing additive, such as dicumyl peroxide, leads to a significant drop in mechanical properties such as tensile stress and impact strength properties, suggesting that there is an optimum macro-radical level quite dependent upon the thermal history of the polyolefin. Thus, it has surprisingly been found that mechanical properties may be improved by excluding peroxide-containing additives, such as dicumyl peroxide, from resin compositions, such as those comprising relatively high amounts of recycled polypropylene.

In certain embodiments, a stoichiometric amount of macro-radicals fragments is generated in order to react with the surface treated inorganic particulate (i.e., one pendant reactive double bond reacts with one macro-radical).

Resin Composition

In certain embodiments, based on the total weight of the resin composition, the resin composition comprises
at least 15% by weight polypropylene (PP),
at least about 40% by weight of non-PP polymer,
at least about 1% by weight of a compatabilizer comprising inorganic particulate material and a surface treatment agent on a surface of the inorganic particulate, and is substantially free of a peroxide-containing additive.

In certain embodiments, the resin composition comprise less than 24% by weight polypropylene, for example, less than 23% by weight polypropylene, or less than 22% by weigh polypropylene, or less than 21% by weight polypropylene, or less than 20% polypropylene, or equal to or less than about 19. % by weight polypropylene.

In certain embodiments, the resin composition comprises from 16-19% by weight polypropylene, for example, from 17-18% by weight polypropylene, or about 17% by weight polypropylene, for example about 17.0% by weight polypropylene.

In certain embodiments, all of the polypropylene is recycled polypropylene.

In certain embodiments, all or at least a portion of (e.g., at least 50%, or at least 75%, or at least about 90%, or at least 90%, or at least 95%, or at least 99%, or at least 99.9%) the polypropylene is derived from a mixed recycled polyolefin stream comprising polypropylene and at least a portion of the non-PP polymer of the resin composition.

In certain embodiments, the non-PP polymer comprises, consists essentially of, or consists of, polyethylene. The polyethylene may comprise at least two different types of polyethylene, for example, at least two different types of recycled polyethylene, for example, a recycled HDPE and at least one other type of polyethylene, e.g., HDPE, from another recycled source.

In certain embodiments, all or at least a portion of (e.g., at least 50%, or at least 75%, or at least about 90%, or at least 90%, or at least 95%, or at least 99%, or at least 99.9%) the polymeric component of the resin composition is derived from polymer waste, for example, post-consumer polymer waste, post-industrial polymer waste, and/or post-agricultural waste polymer. In certain embodiments, all or at least a portion of (e.g., at least 50%, or at least 75% or at least about 90%, or at least 90%, or at least 95%, or at least 99%, or at least 99.9%) the polymeric component of the resin composition is or derived from recycled post-consumer polymer waste.

In certain embodiments, the resin composition comprises at least about 50% by weight polyethylene, for example, from about 50-75% by weight polyethylene, or from about 60-75% polyethylene, or from 65-75% by weight polyethylene.

In certain embodiments, the resin composition comprises a mixture of different types of polyethylene, e.g., HDPE, LDPE and/or LLDPE. Generally, HDPE is understood to be a polyethylene polymer mainly of linear, or unbranched, chains with relatively high crystallinity and melting point, and a density of about 0.96 g/cm³ or more. Generally, LDPE (low density polyethylene) is understood to be a highly branched polyethylene with relatively low crystallinity and melting point, and a density of from about 0.91 g/cm³ to about 0.94 g/cm. Generally, LLDPE (linear low density polyethylene) is understood to be a polyethylene with significant numbers of short branches, commonly made by copolymerization of ethylene with longer-chain olefins. LLDPE differs structurally from conventional LDPE because of the absence of long chain branching.

In certain embodiments, at least 75% by weight, for example; 90-99% by weight, of the polymer in the resin composition is a mixture of polyethylene and polypropylene, for example, a mixture of HDPE and polypropylene (based on the total weight of polymer in the resin composition)

In certain embodiments, the HDPE, when present, is a mixture of HDPE from different sources, for example, from different types of post-consumer polymer waste, e.g., recycled blow-moulded HDPE and/or recycled injection moulded HDPE.

In accordance with the first aspect 1(a), the resin composition comprises greater than about 50% by weight polypropylene (PP), for example, at least about 60% by weight, or at least about 65% by weight, or at least about 70% by weight, or at least about 75% by weight, or at least about 80% by weight, or at least about 85% by weight PP, based on the total weight of the resin composition. In this and other embodiments, the resin composition may comprise up to about 30% by weight of a non-PP polymer such as polyethylene (PE), for example, up to about 20% by weight PE, or up to about 10% by weight PE, or up to about 5% by weight PE, or up to about 2% by weight PE, or up to about 1% PE, or up to about 0.5% by weight PE, or up to about 0.1% by weight PE. In certain embodiments, and other than impact modifier when present, the resin composition is free of polymer other than PP. In other words, in certain embodiments, excluding any impact modifier that may be present, the polymer component of the resin composition is 100% PP.

In certain embodiments, the resin composition comprises no more than about 20% by weight of virgin polymer, based on the total weight of the resin composition, for example, no more than about 10% by weight of virgin polymer, or no more than about 5% by weight of virgin polymer, or no more than about 1% by weight of virgin polymer, or no more than about 0.1% by weight of virgin polymer.

In certain embodiments, the resin composition is free of virgin polymer.

In certain embodiments, all of the polymer in the resin composition is recycled polymer, e.g., derived from polymer waste such as, for example, post-consumer waste.

In certain embodiments, the polymer resin (i.e., comprising the compatibilizer and additional optional components) has a density of greater than about 0.925 g/cm³, for example, equal to or greater than about 0.95 g/cm³, or equal to or greater than about 0.975 g/cm³, or equal to or greater than about 1.00 g/cm³. In certain embodiments, the density is no greater than about 1.25 g/cm³, for example, no greater than about 1.10 g/cm³, or no greater than about 1.05 g/cm³. Density may be determined in accordance with IS01183.

In certain embodiments, the resin composition has, in the absence of peroxide-containing additive, a MFI (melt flow index) of at least about 2 g/10 min (5.0 kg©190° C.), for example, at least about 3 g/10 min (5.0 kg©190° C.), or at least about 4 g/10 min (5.0 kg©190° C.), or at least about 5 g/10 min (5.0 kg©190° C.), or at least about 6 g/10 min (5.0 kg©190° C.). In certain embodiment, the resin composition has a MFI of no greater than about 10 g/10 min (5.0 kg©190° C.), for example, no greater than about to 8 g/10 min (5.0 kg©190° C.), or no greater than about 6 g/10 min (5.0 kg©190° C.), or no greater than about 4 g/10 min (5.0 kg©190° C.). MFI may be determined in accordance with ISO 1133.

In certain embodiments, for example, certain embodiments of the first aspect 1(a), the resin composition has, in the absence of a peroxide-containing additive, a MFI of at least about 3.0 g/10 min (2.16 kg©190° C.), for example, at least about 4.0 g/10 min (2.16 kg©190° C.), or at least about 5.0 g/10 min (2.16 kg©190° C.), or at least about 6.0 g/10 min (2.16 kg©190° C.). In certain embodiment, the resin composition has a MFI of no greater than about 10 g/10 min (2.16 kg©190° C.), for example, no greater than about to 8.0 g/10 min (2.16 kg©190° C.).

In certain embodiments, as described herein, the resin composition comprises a secondary filler, for example, carbon black, for example, from about 0.1-5% by weight carbon black, for example, 0.5-2.0% by weight carbon black.

In certain embodiments, as described herein, the resin composition comprises an impact modifier, for example, from about 1-20% by weight impact modifier, or from about 2-10%, or from about 2-7%, or from about 2-5% by weight of an impact modifier.

In certain embodiments, the resin composition comprises antioxidant, for example, up to about 5% by weight antioxidant, or from about 0.1-1% by weight antioxidant, or from about 0.1-0.5% by weight antioxidant.

In certain embodiments, the resin composition consists essentially of:

at least 15% by weight polypropylene, for example, from 15% by weight to less than 20% by weight polypropylene,

from 50-75% by weight by weight polyethylene, for example, HDPE

from 5-35% by weight compatabilizer, for example, 5-15% by weight compatabilizer, optionally wherein the inorganic particulate is calcium carbonate, optionally having a d50 of less than about 1 μm,

from 0.1-4% by weight carbon black, for example, from 0.5-2.0% by weight carbon black,

from 1-10% by weight impact modifier, for example, 2-5% impact modifier, such as rSBS, and

up to 5% by weight of additional additives other than a peroxide-containing additive, for example, 0.1-1% by weight antioxidant.

In certain embodiments, the resin composition consists of:

from 15% by weight to less than 20% by weight polypropylene,

from 50-75% by weight by weight polyethylene, for example, 60-75% by weight polyethylene, for example, 65-75% by weight polyethylene

from 5-35% by weight compatabilizer, for example, 5-15% by weight compatabilizer,

from 0.5-2% by weight carbon black,

from 1-10% by weight impact modifier, for example, from 2 to 5% by weight impact modifier, and

up to 2% by weight antioxidant, for example, from 0.1-0.5% by weight antioxidant with the proviso that the total weight of components in the resin sum to 100%.

In certain embodiments, the resin composition consists essentially of:

at least 50% by weight PP, for example, at least 65% by weight PP

from 15-25% by weight PE,

from 2-10% by weight compatabilizer,

from 2-10% by weight impact modifier, and

up to about 5% by weight of additional additives other than a peroxide-containing additive, for example, 0.1-1.0% by weight antioxidant.

In certain embodiments, the resin composition consists of:

from 60-70% by weight PP,

from 20-25% by weight PE,

from 3-7% by weight compatabilizer,

from 3-7% by weight impact modifier, and

up to 2% by weight antioxidant, for example, 0.1-0.5.0% by weight antioxidant, with the proviso that the total weight of components in the resin sum to 100%, and optionally

an MFI of from about 3.0-4.0 g/10 min (2.16 kg©190° C.).

In certain embodiments, the resin composition consists essentially of:

at least 80% by weight PP, for example, at least 85% by weight PP is free of polyethylene,

from 2-10% by weight compatabilizer,

from 2-10% by weight impact modifier, and

up to about 5% by weight of additional additives other than a peroxide-containing additive, for example, 0.1-1.0% by weight antioxidant.

In certain embodiments, the resin composition consists of:

from 85-95% by weight PP, for example, from 88-92% by weight PP is free of polyethylene,

from 3-7% by weight compatabilizer,

from 3-7% by weight impact modifier, and

up to 2% by weight antioxidant, for example, 0.1-0-5.0% by weight antioxidant, with the proviso that the total weight of components in the resin sum to 100%, and optionally an MFI of from about 5.0-7.0 g/10 min (2.16 kg©190° C.).

In such embodiments, including those consisting essentially of, or consisting of, various components, the polypropylene and at least a portion of the polyethylene, when present, is derived from a recycled mixed polyolefin source, and at least a portion of the polyethylene is derived from another recycled source.

In such embodiments, all of the polypropylene and polyethylene may be recycled polypropylene and polyethylene, optionally wherein the impact modifier, when present, may be derived from recycled polymer.

In such embodiments, 90-100% by weight of all polymer in the resin composition, other than impact modifier (which may be rSBS), may be polypropylene and, when present, polyethylene.

In such embodiments, all of the polymer in the resin may be recycled polymer.

Compatabilizer

The resin composition comprises at least about 1% by weight of a compatabilizer. The compatabilizer comprises an inorganic particulate and surface treatment agent on a surface of the inorganic particulate.

The compatabilizer may be present in the resin composition in an amount ranging from about 1% up to about 45% by weight, based on the total weight of the resin composition. For example, from about 2% to about 40% by weight, or from about 3% to about 35% by weight, or from about 4% to about 30% by weight, or from about 5% to about 30% by weight, or from about 5% to about 25% by weight, or from about 5% to about 20% by weight, or from about 5% to about 15% by weight, or from about 5% to about 10% by weight, or from about 8% to about 12% by weight, based on the total weight of the resin composition. The compatabilizer may be present in amount less than or equal to about 40% by weight of the polymeric fibre, for example, less than or equal to about 35% by weight, or less than or equal to about 30% by weight, or less than or equal to about 25% by weight, or less than or equal to about 20% by weight, or less than or equal to about 15% by weight, or less than or equal to about 10% by weight, based on the total weight of the resin composition.

In certain embodiments, for example, certain embodiments of the first aspect 1(a), the compatabilizer may be present in the resin composition in an amount ranging from about 1% by weight to about 10% by weight, based on the total weight of the resin composition, for example, from about 2-10% by weight, or from about 2-8% by weight, or from about 3-7% by weight, or from about 4-6% by weight, or about 5% by weight.

The surface treatment agent (i.e., coupling modifier) may be present in the resin composition in an amount of from about 0.01% by weight to about 4% by weight, based on the total weight of the resin composition, for example, from about 0.02% by weight to about 3.5% by weight, or from about 0.05% by weight to about 1.4% by weight, or from about 0.1% by weight to about 0.7% by weight, or from about 0.15% by weight to about 0.7% by weight, or from about 0.3% by weight to about 0.7% by weight, or from about 0.5% by weight to about 0.7% by weight, or from about 0.02% by weight to about 0.5%, or from about 0.05% by weight to about 0.5% by weight, or from about 0.1% by weight to about 0.5% by weight, or from about 0.15% by weight to about 0.5% by weight, or from about 0.2% by weight to about 0.5% by weight, or from about 0.3% by weight to about 0.5% by weight, based on the total weight of the resin composition.

In certain embodiments, the surface treatment agent comprises a first compound including a terminating propanoic group or ethylenic group with one or two adjacent carbonyl groups. The surface treatment agent may be coated on the surface of the inorganic particulate. A purpose of the surface treatment agent (e.g., coating) is to improve the compatibility of the inorganic particulate filler and the polymer matrix with which it is to be combined, and/or improve the compatibility of two or more different polymers in a or the recycled resin composition by cross-linking or grafting the different polymers. In recycled polymer resin compositions comprising recycled and optionally virgin polymer, the functional filler coating may serve to cross-link or graft the different polymers. Without wishing to be bound by theory, it is believed that coupling involves a physical (e.g., steric) and/or chemical (e.g., chemical bonding, such as covalent or van der Waals) interaction between the polymers and the surface treatment agent.

In one embodiment, the surface treatment agent (i.e., coupling modifier) has a formula (1):

A-(X—Y—CO)ₘ(O—B—CO)ₙOH (1)
wherein
A is a moiety containing a terminating ethylenic bond with one or two adjacent carbonyl groups;
X is O and m is 1 to 4 or X is N and m is 1;
Y is C₁₋₁₈-alkylene or C₂₋₁₈-alkenylene;
B is Cm-alkylene; n is 0 to 5;
   provided that when A contains two carbonyl groups adjacent to the ethylenic group, X is N.

In an embodiment, A-X— is the residue of acrylic acid, optionally wherein (O—B—CO)ₙ is the residue of δ-valerolactone or ε-caprolactone or a mixture thereof, and optionally wherein n is zero.

In another embodiment, A-X— is the residue of maleimide, optionally wherein (O—B—CO)ₙ is the residue of δ-valerolactone or ε-caprolactone or a mixture thereof, and optionally wherein n is zero.

Specific examples of coupling modifiers are β-carboxy ethylacrylate, carboxyhexylmaleimide, 10-carboxydecylmaleimide and 5-carboxy pentyl maleimide.

Exemplary coupling modifiers and there methods of preparation are described in U.S. Pat. No. 7,732,514, the entire contents of which is hereby incorporated by reference.

In another embodiment, the coupling modifier is β-acryloyloxypropanoic acid or an oligomeric acrylic acid of the formula (2):

CH₂═CH—COO[CH₂—CH₂—COO]ₙH (2)
wherein n represents a number from 1 to 6.

In an embodiment, n is 1, or 2, or 3, or 4, or 5, or 6.

The oligomeric acrylic acid of formula (2) may be prepared by heating acrylic acid in the presence of 0.001 to 1% by weight of a polymerization inhibitor, optionally under elevated pressure and in the presence of an inert solvent, to a temperature in the range from about 50° C. to 200° C. Exemplary coupling modifiers and their methods of preparation are described in U.S. Pat. No. 4,267,365, the entire contents of which is hereby incorporated by reference.

In another embodiment, the coupling modifier is β-acryloyloxypropanoic acid. This species and its method of manufacture is described in U.S. Pat. No. 3,888,912, the entire contents of which is hereby incorporated by reference.

The surface treatment agent/coupling modifier is present in the compatabilizer in an amount effective to achieve the desired result. This will vary between coupling modifiers and may depend upon the precise composition of the inorganic particulate. For example, the coupling modifier may be present in an amount equal to or less than about 5 wt. % based on the total weight of the compatabilizer, for example equal to or less than about 2 wt. % or, for example equal to or less than about 1.5 wt. %. In an embodiment, the coupling modifier is present in the compatabilizer in an amount equal to or less than about 1.2 wt. % based on the total weight of the compatabilizer, for example equal to or less than about 1.1 wt. %, for example equal to or less than about 1.0 wt. %, for example, equal to or less than about 0.9 wt. %, for example equal to or less than about 0.8 wt. %, for example equal to or less than about 0.7 wt. %, for example, less than or equal to about 0.6 wt. %, for example equal to or less than about 0.5 wt %, for example equal to or less than about 0.4 wt. %, for example equal to or less than about 0.3 wt. %, for example equal to or less than about 0.2 wt. % or, for example less than about 0.1 wt. %. Typically, the coupling modifier is present in the compatabilizer in an amount greater than about 0.05 wt. %. In further embodiments, the coupling modifier is present in the compatabilizer in an amount ranging from about 0.1 to 2 wt. % or, for example, from about 0.2 to about 1.8 wt. %, or from about 0.3 to about 1.6 wt. %, or from about 0.4 to about 1.4 wt. %, or from about 0.5 to about 1.3 wt. %, or from about 0.6 to about 1.2 wt. %, or from about 0.7 to about 1.2 wt. %, or from about 0.8 to about 1.2 wt. %, or from about 0.8 to about 1.1 wt. %.

In certain embodiments, a compound/compounds including a terminating propanoic group or ethylenic group with one or two adjacent carbonyl groups is/are the sole species present in the surface treatment agent.

In certain embodiments, the surface treatment agent additionally comprises a second compound selected from the group consisting of one or more fatty acids and one or more salts of fatty acids, and combinations thereof.

In one embodiment, the one or more fatty acids is selected from the group consisting of lauric acid, myristic acid, palmitic acid, stearic acid, arachidic acid, behenic acid, lignoceric acid, cerotic acid, myristoleic acid, palmitoleic acid, sapienic acid, oleic acid, elaidic acid, vaccenic acid, linoleic acid, linoelaidic acid, α-linolenic acid, arachidonic acid, eicosapentaenoic, erucic acid, docosahexaenoic acid and combinations thereof. In another embodiment, the one or more fatty acids is a saturated fatty acid or an unsaturated fatty acid. In another embodiment, the fatty acid is a C₁₂-C₂₄ fatty acid, for example, a C₁₆-C₂₂ fatty acid, which may be saturated or unsaturated. In one embodiment, the one or more fatty acids is stearic acid, optionally in combination with other fatty acids.

In another embodiment, the one or more salts of a fatty acid is a metal salt of the aforementioned fatty acids. The metal may be an alkali metal or an alkaline earth metal or zinc. In one embodiment, the second compound is calcium stearate.

The second compound, when present, is present in the compatabilizer in an amount effective to achieve the desired result. This will vary between coupling modifiers and may depend upon the precise composition of the inorganic particulate. For example, the second compound may be present in an amount equal to or less than about 5 wt. % based on the total weight of the compatabilizer, for example equal to or less than about 2 wt. % or, for example equal to or less than about 1 wt. %. In an embodiment, the, second compound is present in the compatabilizer in an amount equal to or less than about 0.9 wt.% based on the total weight of the compatabilizer, for example equal to or less than about 0.8 wt. %, for example equal to or less than about 0.7 wt. %, for example, less than or equal to about 0.6 wt. %, for example equal to or less than about 0.5 wt %, for example equal to or less than about 0.4 wt. %, for example equal to or less than about 0.3 wt. %, for example equal to or less than about 0.2 wt. % or, for example equal to or less than about 0.1 wt. %. Typically, the second compound, if present, is present in the compatabilizer in an amount greater than about 0.05 wt. %. The weight ratio of the coupling modifier to the second compound may be from about 5:1 to about 1:5, for example, from about 4:1 to about 1:4, for example, from about 3:1 to about 1:3, for example, from about 2:1 to about 1:2 or, for example, about 1:1. The amount of coating, comprising the first compound (i.e., the coupling modifier) and the second compound (i.e., the one more fatty acids or salts thereof), may be an amount which is calculated to provide a monolayer coverage on the surface of the inorganic particulate. In embodiments, the weight ratio of the first compound to the second compound is from about 4:1 to about 1:3, for example from about 4:1 to about 1:2, for example from about 4:1 to about 1:1, for example from about 4:1 to about 2:1, for example, from about 3.5:1 to about 1:1, for example from about 3.5:1 to 2:1 or, for example, from about 3.5:1 to about 2.5:1

In certain embodiments, the surface treatment agent does not comprise a compound selected from the group consisting of one or more fatty acids and one or more salts of a fatty acid.

In certain embodiments, the surface agent is or comprises an organic linker on a surface of the inorganic particulate. The organic linker has an oxygen-containing acid functionality. The organic linker is a basic form of an organic acid. By “basic form” is meant that the organic acid is at least partially deprotonated, e.g., by dehydrating an organic acid to form the corresponding oxyanion. In certain embodiments, the basic form of an organic acid is the conjugate base of the organic acid. The organic acid (and, thus, the organic linker) comprises at least one carbon-carbon double bond.

In certain embodiments, the organic linker is a non-polymeric species and, in certain embodiments, has a molecular mass of no greater than about 400 g/mol. By “non-polymeric” is meant a species which (i) is not formed by the polymerization of monomeric species, and/or (ii) has a relatively low molecular mass, e.g., a molecular mass of less than about 1000 g/mol, for example, a molecular mass of no greater than about 400 g/mol, and/or (iii) comprises no more than 70 carbon atoms in a carbon chain, for example, no more than about 25 carbon atoms in a carbon chain.

In certain embodiments, the non-polymeric species has a molecular mass of no greater than about 800 g/mol, or no greater than about 600 g/mol, or no greater than about 500 g/mol, or no greater than about 400 g/mol, or no greater than about 300 g/ mol, or no greater than about 200 g/mol. Alternatively or additionally, in certain embodiments, the non-polymeric species comprises no more than about 50 carbon atoms, or no more than about 40 carbon atoms, or no more than about 30 carbon atoms, or no more than about 25 carbon atoms, or no more than about 20 carbon atoms, or no more than about 15 carbon atoms.

In certain embodiments, the compatibilizer comprises particulate and an organic linker (serving as the coupling modifier) on a surface of the particulate, the compatibilizer being obtained by at least partially dehydrating an organic acid having an oxygen-containing acid functionality and comprising at least one carbon-carbon double bond in the presence of the particulate.

An exemplary organic acid is a carboxylic acid, and its basic form a carboxylate, e.g.,

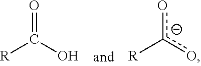

respectively, wherein R is an unsaturated C₂₊ group containing at least one carbon-carbon double bond. The carboxylate group (which is an oxyanion) is depicted in resonance form. The carboxylate group is an example of a conjugate base. In certain embodiments, R is an unsaturated C₃₊ group, or an unsaturated C₄₊ group, or an unsaturated C₅₊ group.

Without wishing to be bound by theory, it is believed that the basic form of the acid functionality coordinates/associates with the surface of the particulate, and the organic tail having at least one carbon-carbon double bond coordinates/associates with the different polymer species in the resin composition. Thus, the compatibilizer serves to cross-link or graft the different polymer types, with the organic linker acting as coupling modifier, wherein the coupling involves a physical (e.g., steric) and/or chemical (e.g., chemical bonding, such as covalent or van der Waals) interaction between the different polymers and between the polymers and the particulate. The overall effect is to enhance the compatibility of the different polymer types in the polymer blend which, in turn, may enhance processing of the polymer blend and/or one or more physical properties (e.g., one or more mechanical properties) of an article of manufacture made from the polymer blend. The surface of the particulate may serve to balance the anionic charge of the organic linker. Further, the compatibilizing effect may enable greater quantities of particulate to be incorporated without adversely affecting the processability of the polymer blend and/or the physical properties of the articles made from the polymer blend. This, in turn, may reduce costs because less polymer (recycled or otherwise) is used.

In certain embodiments, the organic linker is the conjugate base of an organic acid, for example, a carboxylate or phosphate or phosphite or phosphinate or amino acid. In certain embodiments, the organic linker is a carboxylate. In alternate embodiments, the organic linker includes a maleimide ring (e.g., with an amide carboxylate functionality coordinates/associates with the surface of the particulate and an a carbon-carbon double bond coordinates/associates with the different polymer species in the polymer blend).

In certain embodiments, the organic linker comprises at least one carbon atom in addition to the carbon-carbon double bond. In certain embodiments, the organic linker comprises at least two carbon atoms, or at least three carbon atoms, or at least four carbon atoms, or at least five carbon atoms in addition to the carbon-carbon double bond. In certain embodiments, the organic linker comprises at least six carbon atoms, for example, a chain of at least six carbon atoms, including the at least one carbon-carbon double bond. In certain embodiments, the organic linker comprises only one carbon-carbon double bond. In certain embodiments, the organic linker comprises two carbon-carbon double bonds. In certain embodiments, the organic linker comprises three carbon-carbon double bonds. The moieties about the at least one carbon-carbon double bond may be arranged in a cis or trans configuration. The carbon-carbon double bond may be a terminal group or may be internal to the molecule, i.e., within the chain of carbon atoms.

In certain embodiments, the organic linker is:

CH₂═CH—(CH₂)ₐ—Z (1)

and/or

CH₃—(CH₂)_{b}—CH═CH—(CH₂)_{c}—Z (2)

wherein a is equal to or greater than 3;

wherein b is equal to or greater than 1, and c is equal to or greater than 0, provided that b+c is at least 2; and

wherein Z is a carboxylate group, a phosphate group, a phosphite or a phosphinate group.

In certain embodiments, a is from 6 to 20, for example, from 6 to 18, or 6 to 16, or 6 to 14, or 6 to 12, or 6 to 10, or 7 to 9. In certain embodiments, a is 8.

In certain embodiments, b and c are each independently from 4 to 10, for example, each independently from 5 to 11, or from 5 to 10, or from 6 to 9, or from 6 to 8. In certain embodiments, b and c are both 7.

In certain embodiments, when the organic linker is of formula (1), Z is a carboxylate group. In such embodiments, the compatibilizer may consist essentially of, or consist of, particulate (e.g., mineral particulate) and the organic linker of formula (1) and wherein Z is a carboxylate group.

In certain embodiments, when the organic linker is of formula (2), Z is a carboxylate group. In such embodiments, the compatibilizer may consist essentially of, or consist of, particulate (e.g., mineral particulate) and the organic linker of formula (2) and wherein Z is a carboxylate group.

In certain embodiments, the organic linker is a mixture of formula (1) and formula (2), optionally wherein Z is, in each case, a carboxylate group. In such embodiments, the compatibilizer may consist essentially of, or consist of, particulate (e.g., mineral particulate) the organic linker of formula (1) and wherein Z is a carboxylate group, and the organic linker of formula (2) and wherein Z is a carboxylate group.

In certain embodiments, the organic acid is an unsaturated fatty acid or derived from an unsaturated fatty acid. In certain embodiments, when the organic acid is an unsaturated fatty acid, the compatibilizer consists essentially of, or consists of, particulate (for example, mineral particulate) and organic linker. In such embodiments, the unsaturated fatty acid may be selected from one of myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucuc acid and docosahexanoic acid. In such embodiments, the unsaturated fatty acid may be oleic acid, i.e., in certain embodiments, the compatibilizer comprises particulate (for example, mineral particulate) and the basic form of oleic acid. In certain embodiments, the compatibilizer consists of particulate (for example, mineral particulate) and the basic form of oleic acid.

In certain embodiments, the organic acid is derived from an unsaturated fatty acid. In certain embodiments, the organic acid is undecylenic acid, i.e., the organic linker is the basic form of undecylenic acid. In certain embodiments, the compatibilizer consists of particulate (for example, mineral particulate) and the basic form of undecylenic acid.

The Inorganic Particulate Material

The inorganic particulate material may, for example, be an alkaline earth metal carbonate or sulphate, such as calcium carbonate, magnesium carbonate, dolomite, gypsum, a hydrous kandite clay such as kaolin, halloysite or ball clay, an anhydrous (calcined) kandite clay such as metakaolin or fully calcined kaolin, talc, mica, perlite or diatomaceous earth, or magnesium hydroxide, or aluminium trihydrate, or combinations thereof.

A preferred inorganic particulate material is calcium carbonate. Hereafter, the invention may tend to be discussed in terms of calcium carbonate, and in relation to aspects where the calcium carbonate is processed and/or treated. The invention should not be construed as being limited to such embodiments.

The particulate calcium carbonate used in the present invention may be obtained from a natural source by grinding. Ground calcium carbonate (GCC) is typically obtained by crushing and then grinding a mineral source such as chalk, marble or limestone, which may be followed by a particle size classification step, in order to obtain a product having the desired degree of fineness. Other techniques such as bleaching, flotation and magnetic separation may also be used to obtain a product having the desired degree of fineness and/or colour. The particulate solid material may be ground autogenously, i.e. by attrition between the particles of the solid material themselves, or, alternatively, in the presence of a particulate grinding medium comprising particles of a different material from the calcium carbonate to be ground. These processes may be carried out with or without the presence of a dispersant and biocides, which may be added at any stage of the process.

Precipitated calcium carbonate (PCC) may be used as the source of particulate calcium carbonate in the present invention, and may be produced by any of the known methods available in the art. TAPPI Monograph Series No 30, “Paper Coating Pigments”, pages 34-35 describes the three main commercial processes for preparing precipitated calcium carbonate which is suitable for use in preparing products for use in the paper industry, but may also be used in the practice of the present invention. In all three processes, a calcium carbonate feed material, such as limestone, is first calcined to produce quicklime, and the quicklime is then slaked in water to yield calcium hydroxide or milk of lime. In the first process, the milk of lime is directly carbonated with carbon dioxide gas. This process has the advantage that no by-product is formed, and it is relatively easy to control the properties and purity of the calcium carbonate product. In the second process the milk of lime is contacted with soda ash to produce, by double decomposition, a precipitate of calcium carbonate and a solution of sodium hydroxide. The sodium hydroxide may be substantially completely separated from the calcium carbonate if this process is used commercially. In the third main commercial process the milk of lime is first contacted with ammonium chloride to give a calcium chloride solution and ammonia gas. The calcium chloride solution is then contacted with soda ash to produce by double decomposition precipitated calcium carbonate and a solution of sodium chloride. The crystals can be produced in a variety of different shapes and sizes, depending on the specific reaction process that is used. The three main forms of PCC crystals are aragonite, rhombohedral and scalenohedral, all of which are suitable for use in the present invention, including mixtures thereof.

Wet grinding of calcium carbonate involves the formation of an aqueous suspension of the calcium carbonate which may then be ground, optionally in the presence of a suitable dispersing agent. Reference may be made to, for example, EP-A-614948 (the contents of which are incorporated by reference in their entirety) for more information regarding the wet grinding of calcium carbonate. The inorganic particulate, e.g., calcium carbonate, may also be prepared by any suitable dry grinding technique.

In some circumstances, additions of other minerals may be included, for example, one or more of kaolin, calcined kaolin, wollastonite, bauxite, talc, titanium dioxide or mica, could also be present.

When the inorganic particulate material is obtained from naturally occurring sources, it may be that some mineral impurities will contaminate the ground material. For example, naturally occurring calcium carbonate can be present in association with other minerals. Thus, in some embodiments, the inorganic particulate material includes an amount of impurities. In general, however, the inorganic particulate material used in the invention will contain less than about 5% by weight, preferably less than about 1% by weight, of other mineral impurities.

Unless otherwise stated, particle size properties referred to herein for the inorganic particulate materials are as measured by the well known conventional method employed in the art of laser light scattering, using a CILAS 1064 instrument (or by other methods which give essentially the same result). In the laser light scattering technique, the size of particles in powders, suspensions and emulsions may be measured using the diffraction of a laser beam, based on an application of Mie theory. Such a machine provides measurements and a plot of the cumulative percentage by volume of particles having a size, referred to in the art as the ‘equivalent spherical diameter’ (e.s.d), less than given e.s.d values. The mean particle size d₅₀ is the value determined in this way of the particle e.s.d at which there are 50% by volume of the particles which have an equivalent spherical diameter less than that d₅₀ value. The term d₉₀ is the particle size value less than which there are 90% by volume of the particles.

The d₅₀ of the inorganic particulate may be less than about 100 μm, for example, less than about 80 μm for example, less than about 60 μm for example, less than about 40 μm, for example, less than about 20 μm, for example, less than about 15 μm, for example, less than about 10 μm, for example, less than about 8 μm, for example, less than about 6 μm, for example, less than about 5 μm, for example, less than about 4, for example, less than about 3 μm, for example less than about 2 μm, for example, less than about 1.5 μm or, for example, less than about 1 μm. The d₅₀ of the inorganic particulate may be greater than about 0.5 μm, for example, greater than about 0.75 μm greater than about 1 μm, for example, greater than about 1.25 μm or, for example, greater than about 1.5 μm. The d₅₀ of the inorganic particulate may be in the range of from 0.5 to 20 μm, for example, from about 0.5 to 10 μm, for example, from about 1 to about 5 μm, for example, from about 1 to about 3 μm, for example, from about 1 to about 2 μm, for example, from about 0.5 to about 2 μm or, for example, from about 0.5 to 1.5 μm, for example, from about 0.5 to about 1.4 μm, for example, from about 0.5 to about 1.4 μm, for example, from about 0.5 to about 1.3 μm, for example, from about 0.5 to about 1.2 μm, for example, from about 0.5 to about 1.1 μm, for example, from about 0.5 to about 1.0 μm, for example, from about 0.6 to about 1.0 μm, for example, from about 0.7 to about 1.0 μm, for example about 0.6 to about 0.9 μm, for example, from about 0.7 to about 0.9 μm.

The d₉₀ (also referred to as the top cut) of the inorganic particulate may be less than about 150 μm, for example, less than about 125 μm for example, less than about 100 μm for example, less than about 75 μm, for example, less than about 50 μm, for example, less than about 25 μm, for example, less than about 20 μm, for example, less than about 15 μm, for example, less than about 10 μm, for example, less than about 8 μm, for example, less than about 6 μm, for example, less than about 4 μm, for example, less than about 3 μm or, for example, less than about 2 μm. Advantageously, the d₉₀ may be less than about 25 μm.

The amount of particles smaller than 0.1 μm is typically no more than about 5% by volume.

The inorganic particulate may have a particle steepness equal to or greater than about 10.

Particle steepness (i.e., the steepness of the particle size distribution of the inorganic particulate) is determined by the following formula:

Steepness=100×(d₃₀/d₇₀),

wherein d₃₀ is the value of the particle e.s.d at which there are 30% by volume of the particles which have an e.s.d less than that d₃₀ value and d₇₀ is the value of the particle e.s.d. at which there are 70% by volume of the particles which have an e.s.d. less that that d₇₀ value.

The inorganic particulate may have a particle steepness equal to or less than about 100. The inorganic particulate may have a particle steepness equal to or less than about 75, or equal to or less than about 50, or equal to or less than about 40, or equal to or less than about 30. The inorganic particulate may have a particle steepness from about 10 to about 50, or from about 10 to about 40.

The inorganic particulate is treated with a surface treatment agent, i.e., a coupling modifier, such that the inorganic particulate has a surface treatment on its surface. In certain embodiments, the inorganic particulate is coated with the surface treatment agent.

In certain embodiments, the inorganic particulate material of the compatabilizer is calcium carbonate, for example, GCC.

According to certain aspects and embodiments thereof, the resin composition is substantially free of, i.e., does not comprise, a peroxide-containing additive, for example, di-cumyl peroxide or 1,1-Di(tert-butylperoxy)-3,3,5-trimethylcyclohexane.

Alternatively, in certain aspects and embodiments thereof, the resin composition comprises a peroxide-containing additive, for example, di-cumyl peroxide or 1,1-Di(tert-butylperoxy)-3,3,5-trimethylcyclohexane. The peroxide-containing additive may not necessarily be included with the surface treatment agent/coupling modifier and instead may be added during the compounding of the compatibilizer and the polymer, as described below. In some polymer systems, e.g., those containing polyethylene (e.g., HDPE), the inclusion of a peroxide-containing additive may promote cross-linking of the polymer chains. In other polymer systems, e.g., polypropylene, the inclusion of a peroxide-containing additive may promote polymer chain scission. The peroxide-containing additive may be present in amount effective to achieve the desired result. This will vary between coupling modifiers and may depend upon the precise composition of the inorganic particulate and the polymer. For example, the peroxide-containing additive may be present in an amount equal to or less than about 1 wt. % based on the weight of the polymer in the resin composition to which the peroxide-containing additive is to be added, for example, equal to or less than about 0.5 wt. %, for example, 0.1 wt %, for example equal to or less than about 0.09 wt. %, or for example equal to or less than about 0.08 wt. % or for example, equal to or less than about 0.06 wt. %. Typically, the peroxide-containing additive, if present, is present in an amount greater than about 0.01 wt. % based on the weight of the polymer in the resin composition.

The compatabilizer may be prepared by combining the inorganic particulate, surface treatment agent/coupling modifier and optional peroxide-containing additive and mixing using conventional methods, for example, using a Steele and Cowlishaw high intensity mixer, preferably at a temperature equal to or less than 80° C. The compound(s) of the surface treatment agent/coupling modifier may be applied after grinding the inorganic particulate, but before the inorganic particulate is added to the optionally recycled polymer composition. For example, the surface treatment agent/coupling modifier may be added to the inorganic particulate in a step in which the inorganic particulate is mechanically de-aggregated. The surface treatment agent/couling modifier may be applied during de-aggregation carried out in a milling machine.

The compatabilizer may additionally comprise an antioxidant. Suitable antioxidants include, but are not limited to, organic molecules consisting of hindered phenol and amine derivatives, organic molecules consisting of phosphates and lower molecular weight hindered phenols, and thioesters. Exemplary antioxidants include Irganox 1010 and Irganox 215, and blends of Irganox 1010 and Irganox 215. Alternatively, such antioxidants may be added to the resin composition separately from the compatabilizer. Alternatively, a portion of the total required amount of antioxidant may be present in both the compatabilizer and added separately from the compatabilizer to the resin composition.

### Secondary Filler

In certain embodiments, the resin composition comprises filler in addition to the compatabilizer when present, i.e., one or more secondary filler components. The secondary filler component may not be treated with a surface treatment agent/coupling modifier. In certain embodiments, the secondary filler component is not treated with a surface treatment agent/coupling modifier. Such additional components, where present, are suitably selected from known filler components for polymer compositions. For example, the inorganic particulate used in the functional filler may be used in conjunction with one more other known secondary filler components, such as for example, carbon black and/or talc.

In certain embodiments, the resin composition comprises carbon black as a secondary filler component. The carbon black may function as colorant and/or UV stabiliser.

In certain embodiments, the weight ratio of compatibilizer to secondary filler component is from about 1:1 to about 20:1, for example, from about 5:1 to about 15:1, or from about 7.5:1 to about 12.5:1, for example, about 10:1. In certain embodiments, the inorganic particulate of the functional filler is calcium carbonate, for example, ground calcium carbonate, and the secondary filler component is uncoated carbon black. When a secondary filler component is used, it may be present in an amount of from about 0.1% to about 5% by weight of the polymer composition, for example, from about 0.5% to about 4% by weight, or from about 0.5% to about 3% by weight, or from about 0.5% to about 2.5% by weight, or from about 0.5% to about 2% by weight, or from about 0.5% to about 1.5% by weight, or from about 0.75% to about 1.25% by weight of the resin composition.

The secondary filler component(s) may also serve to increase the density of the resin composition.

In certain embodiments, the secondary filler is present in an amount of at least about 0.5% by weight, based on the total weight of the resin composition.

Impact Modifier

In certain embodiments, the resin composition comprises an impact modifier, for example, up to about 20% by weight of an impact modifier, based on the total weight of the filled polymer resin, for example, from about 0.1% by weight to about 20% by weight, or from about 0.5% by weight to about 15% by weight, or from about 1% by weight to about 10% by weight, or from about 2% by weight to about 5% by weight, or from about 1% by weight to about 10% by weight, or from about 1% by weight to about 8% by weight, or from about 2% by weight to about 6% by weight, or from about 2% by weight to about 5% by weight of an impact modifier, based on the total weight of resin composition. .

In certain embodiments, the impact modifier is an elastomer, for example, a polyolefin elastomer. In certain embodiments, the polyolefin elastomer is a copolymer of ethylene and another olefin (e.g., an alpha-olefin), for example, octane, and/or or butene and/or styrene. In certain embodiments, the impact modifier is a copolymer of ethylene and octene. In certain embodiments, the impact modifier is a copolymer of ethylene and butene.

In certain embodiments, the impact modifier is a recycled (e.g., post industrial) impact modifier.

In certain embodiments, the impact modifier, for example, polyolefin copolymer as described above, such as an ethylene-octene copolymer, has a density of from about 0.80 to about 0.95 g/cm³ and/or a MFI of from about 0.2 g/10 min (2.16 kg@190° C.) to about 30 g/10 min (2.16 kg@190° C.), for example, from about 0.5 g/10 min (2.16 kg@190° C.) to about 20 g/10 min (2.16 kg@190° C.), or from about 0.5 g/10 min (2.16 kg@190° C.) to about 15 g/10 min (2.16 kg@190° C.), or from about 0.5 g/10 min (2.16 kg@190° C.) to about 10 g/10 min (2.16 kg@190° C.), or from about 0.5 g/10 min (2.16 kg@190° C.) to about 7.5 g/10 min (2.16 kg@190° C.), or from about 0.5 g/10 min (2.16 kg@190° C.) to about 5 g/10 min (2.16 kg@190° C.), or from about 0.5 g/10 min (2.16 kg@190° C.) to about 4 g/10 min (2.16 kg@190° C.), or from about 0.5 g/10 min (2.16 kg@190° C.) to about 3 g/10 min (2.16 kg@190° C.), or from about 0.5 g/10 min (2.16 kg@190° C.) to about 2.5 g/10 min (2.16 kg@190° C.), or from about 0.5 g/10 min (2.16 kg@190° C.) to about 2 g/10 min (2.16 kg@190° C.), or from about 0.5 g/10 min (2.16 kg@190° C.) to about 1.5 g/10 min (2.16 kg@190° C.). In such or certain embodiments, the impact modifier is an ethylene-octene copolymer having a density of from about 0.85 to about 0.86 g/cm³. Exemplary impact modifiers are polyolefin elastomers made by DOW under the Engage(®) brand, for example, Engage(®) 8842. In such embodiments, the compounded polymer blend may additionally comprise an antioxidant, as described herein.

In certain embodiments, the impact modifier is a copolymer based on styrene and butadiene, for example, a linear block copolymer based on styrene and butadiene. In such embodiments, the impact modifier may have a MFI of from about from about 1 to about 5 g/10 min (200° C. @ 5.0 kg), for example, from about 2 g/10 min (200° C. @ 5.0 kg) to about 4 g/10 min (200° C. @ 5.0 kg), or from about 3 g/10 min (200° C. @ 5.0 kg) to about 4 g/10 min (200° C. @ 5.0 kg). In such embodiments, the linear block copolymer may be a recycled linear block copolymer.

In certain embodiments, the impact modifier is a copolymer based on styrene and isoprene, for example, a linear block copolymer based on styrene and isoprene. In such embodiments, the impact modifier may have a MFI of from about from about 5 to about 20 g/10 min (230° C. @ 2.16), for example, from about 8 g/10 min (230° C. @ 2.16 kg) to about 15 g/10 min (230° C. @ 2.16 kg), or from about 10 g/10 min (230° C. @ 2.16 kg) to about 15 g/10 min (230° C. @ 2.16 kg). In such embodiments, the linear block copolymer may be recycled.

In certain embodiments, the impact modifier is a triblock copolymer based on styrene and ethylene/butene. In such embodiments, the impact modifier may have a MFI of from about 15 g/10 min (200° C. @ 5.0 kg) to about 25 g/10 min (200° C. @ 5.0 kg), for example, from about 20 g/10 min (200° C. @ 5.0 kg) to about 25 g/10 min (200° C. @ 5.0 kg).

MFI may be determined in accordance with ISO 1133.

In certain embodiments, there is crosslinking between the impact modifier and one or more polymers of the resin composition, for example, in embodiments in which the impact modifier is a linear block copolymer based on styrene and butadiene, or on styrene and isoprene, and/or the resin composition comprises PE. In some embodiments, the impact modifier may be miscible in the polymer blend.

In certain embodiments, the impact modifier is an optionally recycled styrene-butadiene-styrene block copolymer (rSBS). In such embodiments, the rSBS is present in the resin composition in an amount of from about 2% to about 5% by weight, based on the total weight of resin composition

Methods of Manufacture

The resin composition may be made by a method comprising compounding the polypropylene and, when present, non-PP polymer, for example, polyethylene, with the compatabilizer and other optional additives other than a peroxide-containing additive.

In certain embodiments, the method comprises providing a recycled mixed polyolefin feed comprising polypropylene and polyethylene, optionally combining the recycled mixed polyolefin feed with other sources of polyethylene and/or polypropylene, and compounding in the absence of peroxide containing additive.

The relative amounts of polypropylene, non-PP (e.g., polyethylene) and any other polyolefin source may be selected to produce a resin composition as described herein.

In certain embodiments, the method comprises preparing, providing or obtaining the compatibilizer, and compounding with the polymer or mixture of different polymer types. The compatibilizer may be prepared by mixing the inorganic particulate material with the surface treatment agent/coupling in suitable amounts, as described herein, and at a temperature of no more than about 80° C.

In certain embodiments, the resin composition comprises a secondary filler component (e.g., carbon black) and/or impact modifier (e.g., rSBS) and/or antioxidant, which may be added prior to or during compounding of the resin composition and compatibilizer.

Compounding per se is a technique which is well known to persons skilled in the art of polymer processing and manufacture. It is understood in the art that compounding is distinct from blending or mixing processes conducted at temperatures below that at which the constituents become molten.

Compounding may be carried out using a twin screw compounder, for example, a Baker Perkins 25 mm twin screw compounder. The polymers and compatibilizer and other optional additives may be premixed and fed from a single hopper. Alternatively, at least the polymers and compatibilizer may be fed from separate hoppers. The resulting melt may be cooled, for example, in a water bath, and then pelletized. In certain embodiments, the temperature during compounding is elevated relative to the temperature at which the compatabilizer is prepared. In certain embodiments, the temperature during compound ranges from about 150-250° C., for example, from about 160-240° C., or from about 170-230° C., or from about 170-220° C., or from about 170-220° C., or from about 200-250° C. In certain embodiments, the temperature during compounding is sufficient to cause thermo-mechanical degradation of the polyolefins (e.g., recycled polyolefins) and to generate sufficient macro-radical fragments to react with the surface treated inorganic particulate material.

The compounded compositions may further comprise additional components, such as slip aids (for example Erucamide), process aids (for example Polybatch® AMF-705), mould release agents and antioxidants. Suitable mould release agents will be readily apparent to one of ordinary skill in the art, and include fatty acids, and zinc, calcium, magnesium and lithium salts of fatty acids and organic phosphate esters. Specific examples are stearic acid, zinc stearate, calcium stearate, magnesium stearate, lithium stearate, calcium oleate and zinc palmitate.

Slip and process aids, and mould release agents may be added in an amount less than about 5 wt. % based on the weight of the masterbatch.

Polymer articles, for example, cable or cable protection or rotomoulded product, may then be formed by any suitable technique, for example, by extrusion or rotational moulding, using conventional techniques known in the art, as will be readily apparent to one of ordinary skill in the art.

Likewise, polymer articles such as plastic pallets may then be formed by any suitable method, for example, by injection moulding, using conventional techniques known in the art, as will be readily apparent to one of ordinary skill in the art.

The articles which may be formed from the resin composition are many and various.

In certain embodiments, the article is cable or cable protection.

In certain embodiments, the cable is an electric or optical cable, and/or the cable protection is suitable for use in or as an electric or optical cable.

In certain embodiments, the cable or cable protection is compliant with any one or more of International Standard IEC 60502-2 (second edition, 2005-03), IEC 60811-1-1 (Edition 2.1, 2001-07), IEC 60811-2-1 (Edition 2.1, 2001-11).

In certain embodiments, the cable comprises a metallic conductor (e.g., wire), an insulating layer about the conductor, optionally a metallic sheath about the insulating layer, and an outer layer comprising or formed from the resin composition, i.e., the outer layer is the cable protection.

In certain embodiments, the cable or cable protection has one or more of the following:
Density of at least 0.95 g/cm³ (which may be determined in accordance with IS01183);
Hardness of from about 55-60 Shore D;
Elongation at break of at least about 300%;
Tensile strength of at least 18 MPa; and/r
Carbon black content of about 2.5%

In certain embodiments, the article, for example, cable or cable protection, has an ESCR of at least about at least about 50 hours, for example, at least about 150 hours, or at least about 250 hours, or at least about 500 hours, or at least about 750 hours, or at least about 100 hours, or at least about 1500 hours, or at least about 2000 hours, or at least about 2500 hours, or at least about 3000 hours, or at least about 3500 hours, or at least about 4000 hours, or at least about 4500 hours, or at least about 5000 hours, or at least about 6000 hours, or at least about 7000 hours, or at least about 8000 hours, or at least about 9000 hours, or at least about 10,000 hours.

ECSR is a mechanical failure by cracking of a polymer material which occurs in a surface active environment. These are caused by the combined presence of stresses and the surface active agent. The surface active agent does not chemically attack the polymeric components or modify the fracture mechanism. The active environment only accelerates the stress cracking process.

In certain embodiments, ECSR is determined in accordance with ASTM D1693-01 under Condition B. According to this method, ten rectangular-shaped specimens are cut from a moulded plaque prepare with standard methods, for example, in accordance with Procedure C of Annex 1 of Practice D4703 (see section 8.1 of ASTM D1693-01), to the dimensions given in Condition B of ASTM D1693-01. Condition B is typically used for materials having a density greater than about 0.925 g/cm³. Test pieces may be conditioned in accordance with Procedure A of Practice D618 (a minimum of 40 hours at 23° C. and a relative humidity of 50%)—see section 9.1 of ASTM D1693-01.

In accordance with ASTM D1693-01, after 50% of the test pieces have failed the time to failure (F₅₀) is taken. This time to failure, measured in hours, is used to determine and compare the polymers resistance to cracking.

According to certain embodiments, there is provided of making an article having an ESCR of at least about at least about 50 hours, for example, at least about 150 hours, or at least about 250 hours, or at least about 400 hours, or at least about 500 hours, or at least about 750 hours, or at least about 100 hours, or at least about 1500 hours, or at least about 2000 hours, or at least about 2500 hours, or at least about 3000 hours, or at least about 3500 hours, or at least about 4000 hours, or at least about 4500 hours, or at least about 5000 hours, or at least about 6000 hours, or at least about 7000 hours, or at least about 8000 hours, or at least about 9000 hours, or at least about 10,000 hours, as may be determined in accordance with ASTM D1693-01 under Condition B, said method comprising forming said article from a resin composition which is derived from a mixed recycled polyolefin stream comprising polypropylene and polyethylene.

In other embodiments, said recycled mixed polyolefin stream used to manufacture an article, for example, cable or cable protection, having an ESCR of at least about at least about 50 hours, for example, at least about 150 hours, or at least about 250 hours, or at least about 400 hours, or at least about 500 hours, or at least about 750 hours, or at least about 100 hours, or at least about 1500 hours, or at least about 2000 hours, or at least about 2500 hours, or at least about 3000 hours, or at least about 3500 hours, or at least about 4000 hours, or at least about 4500 hours, or at least about 5000 hours, or at least about 6000 hours, or at least about 7000 hours, or at least about 8000 hours, or at least about 9000 hours, or at least about 10,000 hours, as may be determined in accordance with ASTM D1693-01 under Condition B

In certain embodiments, the resin composition comprises at least about 15% by weight polypropylene and at least about 40% by weight polyethylene, at least about 1% by weight of compatabilizer comprising inorganic particulate material and a surface treatment agent on a surface of the inorganic particulate, and comprises or does not comprise a peroxide-containing additive.

In certain embodiments, the article of manufacture is an article that may be manufactured by injection moulding. In certain embodiments, the article of manufacture is a plastic pallet.

### Other Embodiments

In certain embodiments, the resin composition does not comprise 24% by weight polypropylene.

In certain embodiments, the resin composition does not comprise 56% by weight HDPE.

In certain embodiments, the resin composition does not comprise 24% by weight polypropylene and 56% by weight polypropylene.

In certain embodiments, the resin composition does not comprise 20% by weight surface treated calcium carbonate, optionally wherein: the calcium carbonate is a ground calcium carbonate having a d₅₀ of 0.8 μm, and/or the amount of surface treatment according to formula (1) applied to the calcium carbonate is calculated to give a monolayer coverage on the surface.

In certain embodiments, the resin composition is not a polymer composition designated as Composition A. Composition A is a polymer composition comprising 20% by weight surface treated calcium carbonate, 56% HDPE and 24% polypropylene, wherein:
(i) the surface treated calcium carbonate is a ground calcium carbonate (d₅₀=0.8 μm) coated with a coupling modifier according to formula (1), wherein the amount of surface treatment applied to the calcium carbonate is calculated to give monolayer coverage on the surface
(ii) the composition is prepared using a Baker Perkins 25 mm twin screw compounder, and
(iii) the HDPE and PP are from a recycled mixed polyolefin feed comprising HDPE and PP, which is derived from injection moulded materials.

In certain embodiments, the polymeric resin is not in the form of a polymeric fibre.

In certain embodiments, the article is not a polymeric fibre.

In certain embodiments, the polymer resin comprises less than 70% by weight polypropylene, for example, less than 60% by weight polypropylene, or less than 50% by weight polypropylene, or less than 40% by weight polypropylene, or less than 30% by weight polypropylene, or less than 20% by weight polypropylene.

In certain embodiments, for example, embodiments in which resin composition comprises HDPE, the resin composition comprises greater than 20% by weight polypropylene, based on the total weight of the resin composition.

For the avoidance of doubt, the present application is directed to the subject-matter described in the following numbered paragraphs:

1. A resin composition comprising, based on the total weight of the composition: greater than about % by weight polypropylene (PP), or at least about 75% by weight PP up to about 30% by weight polyethylene (PE), or up to about 25% by weight PE, or is free of PE,

at least about 1% by weight of a compatabilizer comprising inorganic particulate material and a surface treatment agent on a surface of the inorganic particulate,

wherein the resin composition is substantially free of a peroxide-containing additive.

2. Resin composition according to numbered paragraph 1, comprising at least about 75% by weight PP, for example, at least about 85% by weight PP.

3. Resin composition according to numbered paragraph 2, comprising at least about 85% by weight PP.

4. Resin composition according to numbered paragraph 3, wherein the resin composition is free of PE.

5. Resin composition according to numbered paragraph 1 or 2, comprising from about 20-25% by weight PE.

6. Resin composition according to any preceding numbered paragraph, wherein all of the PP, or all of the PP and PE, is recycled.

7. Resin composition according to any preceding numbered paragraph, wherein the non-PP polymer, when present, comprises, consists essentially of, or consists of, PE, for example, recycled HDPE.

9. Resin composition according to any preceding numbered paragraph, comprising a secondary filler

10. Resin composition according to any preceding numbered paragraph, comprising an impact modifier, for example, from about 1-20% by weight impact modifier.

11. Resin composition according to any preceding numbered paragraph, comprising antioxidant, for example, up to about 5% by weight antioxidant.

12. Resin composition according to any preceding numbered paragraph, wherein the resin composition consists essentially of:

at least 50% by weight PP, for example, at least 65% by weight PP

from 15-25% by weight PE,

from 2-10% by weight compatabilizer,

from 2-10% by weight impact modifier, and

up to about 5% by weight of additional additives other than a peroxide-containing additive, for example, 0.1-1.0% by weight antioxidant.

13. Resin composition according to numbered paragraph 12, wherein the resin composition consists of:

from 60-70% by weight PP,

from 20-25% by weight PE,

from 3-7% by weight compatabilizer,

from 3-7% by weight impact modifier, and

up to 2% by weight antioxidant, for example, 0.1-0.5.0% by weight antioxidant, with the proviso that the total weight of components in the resin sum to 100%, and optionally

an MFI of from about 3.0-4.0 g/10 min (2.16 kg©190° C.).

14. Resin composition according to any one of numbered paragraphs 1-11, wherein the resin composition consists essentially of:

at least 80% by weight PP, for example, at least 85% by weight PP is free of polyethylene,

from 2-10% by weight compatabilizer,

from 2-10% by weight impact modifier, and

up to about 5% by weight of additional additives other than a peroxide-containing additive, for example, 0.1-1.0% by weight antioxidant.

15. Resin composition according to numbered paragraph 14, wherein the resin composition consists of:

from 85-95% by weight PP, for example, from 88-92% by weight PP is free of polyethylene,

from 3-7% by weight compatabilizer,

from 3-7% by weight impact modifier, and

up to 2% by weight antioxidant, for example, 0.1-0.5.0% by weight antioxidant, with the proviso that the total weight of components in the resin sum to 100%, and optionally an MFI of from about 5.0-7.0 g/10 min (2.16 kg@190° C.).

16. Resin composition according to any preceding numbered paragraph, wherein all of the PP and, when present, PE is recycled, and wherein the impact modifier, when present, is derived from recycled polymer.

17. Resin composition according to any preceding numbered paragraph, wherein 90-100% by weight of all polymer in the resin composition, other than impact modifier, is PP and, when present, PE.

18. Resin composition according to any preceding numbered paragraph, wherein all of the polymer in the resin is recycled polymer.

19. Resin composition according to any preceding numbered paragraph, wherein the resin has an MFI of at least about 3.0 g/10 min (2.16 kg @ 190 C).

20. Resin composition according to any preceding numbered paragraph, wherein the surface treatment agent comprises a first compound having a formula (1):

A-(X—Y—CO)ₘ(O—B—CO)ₙOH (1)
wherein

A is a moiety containing a terminating ethylenic bond with one or two adjacent carbonyl groups;

X is O and m is 1 to 4 or X is N and m is 1;

Y is C₁₋₁₈-alkylene or C₂₋₁₈-alkenylene;

B is Cm-alkylene; n is 0 to 5;

provided that when A contains two carbonyl groups adjacent to the ethylenic group, X is N.

21. Resin composition according to numbered paragraph 20, wherein the first compound is selected from ß-carboxy ethylacrylate, ß-carboxyhexylmaleimide, 10-carboxydecylmaleimide, 5-carboxy pentyl maleimide and ß-acryloyloxypropanoic acid.

22. Resin composition according to any one of numbered paragraphs 1-19, wherein the compatabilizer comprises inorganic particulate material and an organic linker on a surface of the particulate, wherein the organic linker has an oxygen-containing acid functionality, and wherein the organic linker is a basic form of an organic acid.

23. An article of manufacture comprising or formed from the resin composition according to any preceding numbered paragraph.

24. Article according to numbered paragraph 23, wherein the article is a plastic pallet.

25. Use of a resin composition according to any one of numbered paragraphs 1-22 in the manufacture of an article of manufacture.

26. Use according to numbered paragraph 25, wherein the article is a plastic pallet.

27. A method of making a resin composition according to any one of numbered paragraph 1-22, comprising compounding the PE and, when present, non-PP polymer, for example, polyethylene, with the compatabilizer and other optional additives other than a peroxide-containing additive.

28. A method according to numbered paragraph 27, providing a recycled mixed polyolefin feed comprising polypropylene and polyethylene, optionally combining the recycled mixed polyolefin feed with other sources of polyethylene and/or polypropylene, and compounding in accordance with numbered paragraph 27.

29. A method of making a plastic pallet, the method comprising injection moulding a resin composition according to any one of numbered paragraphs 1-22 to form said plastic pallet, optionally wherein the method further comprises making the resin composition in accordance with numbered paragraphs 27 or 28.

### EXAMPLES

### Example 1

Six polymer resins were prepared as shown in Table 1 below. All polymer resins were prepared via melt mixing with a Coperion ZSK¹⁸ twin-screw extruder. The screw speed was set to 800 rpm, and the feed rate at 8.0 kg/h. The hot extrudates were immediately quenched in water and pelletized.

Melt Flow Index (MFI) properties of the six polymer resin samples were determined. MFI is the output rate in grams that occurs in 10 minutes when a fixed pressure is applied to the melt via a piston and a load of total mass of 2.16 kg at the melt blending temperature of 190° C. MFI was tested in accordance with ISO 1133. The MFI properties of the polymer resin samples 1-6 is provided in Table 1 below.

Injection moulded samples were prepared from the six polymer resins, that were prepared in Example 1, using Arburg Allrounder 320M, and mouldings were conditioned for a minimum of 40 hrs at 23° C. and a relative humidity of 50% prior to the test, in accordance with Procedure A of Practice D618 (40/23/50).

Each injection moulded sample subsequently underwent the following mechanical property tests.

Flexure Testing:

Flexure tests were carried out at room temperature using Tinius Olsen Benchtop flexure test, in accordance with ISO 178. The flexure test results are provided in Table 1 below.

Tensile Testing:

Tensile tests were carried out at room temperature using Tinius Olsen Benchtop tensile tester, and the results supplied correspond to an average of 8 measurements for each blend, in accordance with ISO 527-2. Table 1 below shows the tensile stress at yield (MPa) and break (%) of each injection moulded sample.

Impact Testing:

Charpy notched impact tests were carried out at −20±2° C. using an Instron Ceast 9340 falling-weight impact tester, in accordance with ISO 179-2. The results supplied in Table 1 below correspond to an average of complete break measurements for each blend.

TABLE 1

| | | 1 | 2 | 3 | 4 | 5 | 6 |
|---|---|---|---|---|---|---|---|
| Formulations | Recycled HDPE (wt. %) | 22.425 | 22.42 | 22.415 | — | — | — |
| | Recycled PP (wt. %) | 67.275 | 67.27 | 67.265 | 89.70 | 89.69 | 89.68 |
| | Compatabilizer (wt. %) | 5.0 | 5.0 | 5.0 | 5.0 | 5.0 | 5.0 |
| | Impact modifier (wt. %) | 5.0 | 5.0 | 5.0 | 5.0 | 5.0 | 5.0 |
| | Dicumyl Peroxide (wt. %) | — | 0.01 | 0.02 | — | 0.01 | 0.02 |
| | Anti-oxidant (wt. %) | 0.3 | 0.3 | 0.3 | 0.3 | 0.3 | 0.3 |
| | Total (wt. %) | 100 | 100 | 100 | 100 | 100 | 100 |
| Test Results | Flexural Modulus (MPa) | 929.5 | 915.8 | 901.9 | 953.0 | 932.0 | 946.6 |
| | Charpy Impact Strength, | 87.6 | 67.8 | 58.2 | 42.5 | 31.9 | 30.7 |
| | Unnotch @−20° C., | | | | | | |
| | Complete Break (KJ/m²) | | | | | | |
| | Tensile Stress @ Yield | 20.8 | 20.9 | 20.6 | 21.2 | 20.5 | 20.4 |
| | (MPa) | | | | | | |
| | Tensile Strain @ Break | 187.0 | 101.5 | 66.1 | 117.0 | 55.1 | 46.6 |
| | (%) | | | | | | |
| | MFI, 2.16 kg @ 190° C., | 3.31 | 4.03 | 3.88 | 5.43 | 5.85 | 6.25 |
| | (g/10 min) | | | | | | |

1. A resin composition comprising:
at least 15% by weight polypropylene (PP),
at least about 40% by weight of non-PP polymer,
at least about 1% by weight of a compatabilizer comprising inorganic particulate material and a surface treatment agent on a surface of the inorganic particulate,
wherein the resin composition is substantially free of a peroxide-containing additive.

2. A resin composition according to claim 1, comprising less than 24% by weight polypropyiene.

3. A resin composition according to claim 1, comprising from 16-19% by weight polypropylene.

4. (canceled)

5. A resin composition according to claim 3 comprising about 17% by weight polypropylene.

6. A resin composition according to claim 1, wherein the polypropylene is recycled polypropylene.

7. A resin composition according to claim 1, wherein the non-PP polymer comprises from at least two different recycled sources.

8. A resin composition according to claim 1, comprising at least about 50% by weight polyethylene.

9. A resin composition according to claim 1, comprising from about 1-4% by weight carbon black.

10. A resin composition according to claim 1, comprising from about 1-20% by weight impact modifier.

11. A resin composition according to claim 1, comprising up to about 5% by weight antioxidant.

12. A resin composition according to claim 1, wherein the resin composition consists essentially of:
from 15% by weight to less than 20% by weight polypropylene,
from 50-75% by weight by weight polyethylene,
from 5-35% by weight compatabilizer,
from 0.1-4% by weight carbon black,
from 1-10% by weight impact modifier, and
up to 5% by weight of additional additives other than a peroxide-containing additive.

13. (canceled)

14. (canceled)

15. A resin composition according to claim 1, wherein 90-100% by weight of all polymer in the resin composition, other than impact modifier, is polypropylene and polyethylene.

16. A resin composition according to claim 1, wherein all of the polymer in the resin is recycled polymer.

17. A resin composition according to claim 1, wherein the surface treatment agent comprises a first compound having a formula (1):
A-(X—Y—CO)ₘ(O—B—CO)ₙOH (1)
wherein
A is a moiety containing a terminating ethylenic bond with one or two adjacent carbonyl groups;
X is O and m is 1 to 4 or X is N and m is 1;
Y is C₁₋₁₈-alkylene or C₂₋₁₈-alkenylene;
B is C₂₋₆-alkylene; and
n is 0 to 5,
provided that when A contains two carbonyl groups adjacent to the ethylenic group, X is N.

18. A resin composition according to claim 17, wherein the first compound is selected from ß-carboxy ethylacrylate, ß-carboxyhexylmaleimide, 10-carboxydecylmaleimide, 5-carboxy pentyl maleimide and ß-acryloyloxypropanoic acid.

19. A resin composition according to claim 1, wherein the compatabilizer comprises inorganic particulate material and an organic linker on a surface of the particulate, wherein the organic linker has an oxygen-containing acid functionality, and wherein the organic linker is a basic form of an organic acid.

20. A cable or cable protection comprising or formed from the resin composition according to claim 1.

21. (canceled)

22. A cable or cable protection according to claim 20, having an Environmental Stress Crack Resistance (ESCR) of at least about 50 hours as may be determined in accordance with ASTM D1693-01 under Condition B.

23. (canceled)

24. A rotomolded article comprising or formed from a resin composition according to claim 1.

25-31. (canceled)

32. A method of manufacturing an article, the method comprising extruding a resin composition according to claim 1 to form said article, wherein said article is a cable or a cable protection.

33. (canceled)
